(19) United States
(12) Patent Application Publication
(10) Pub. No.: US 2008/0025787 A1
(43) Pub. Date: Jan. 31, 2008

(54) Personal hygiene dispensing packet

(76) Inventor: Sally Shea, Fort Lauderdale, FL (US)

Correspondence Address: AKERMAN SENTERFITT, P.O. BOX 3188, WEST PALM BEACH, FL, 33402-3188, US

(21) Appl. No.: 11/481,118

(22) Filed: Jul. 5, 2006

(51) Int. Cl. B43K 1/06

(52) U.S. Cl. 401/265

(57) ABSTRACT

A medicinal, pharmaceutical, or cosmetic substance intended to be applied to the skin is retained within a cavity formed by two dispensing pads held together during packaging and prior to use, and is applied by separating the pads and applying the substance directly to the skin without the substance coming into contact with the hand or fingers of a user.

### BACKGROUND OF THE INVENTION

In the field of hygienic products, advances have been made with respect to the provision of personalized hygienic products for one-time use by a single individual. Such advances are notable in the areas of shaving, in which single-use razors have become commonplace; toothbrush/toothpaste combinations, in which a single application of toothpaste is provided along with a toothbrush for one-time use; and similar applications. Personalized single-use hygienic products are particularly suitable for dispensing in hotels, gymnasiums, hospitals, and public lavatories, to persons who have not brought larger, “family” sized hygienic products with them.

Despite the increasing use of personalized single-use hygienic products, certain items have not typically been dispensed as single-use, or single-application products. This is because of difficulties in packaging them economically, and because their use has not been particularly convenient to potential users. Underarm deodorants are typical of a class of products that are single application dispensers. Such products generally require more elaborate dispensing units, such as “roller” balls or spheroids that “roll” within the dispenser to contact the substance being dispensed and transfer it to a user's body; or nozzle-activated pressurized containers whose structure and bulk are a necessary adjunct to a pressurized environment. Even in situations in which the contents of a container are not pressurized, a manually-actuated “pump” may be required to draw a substance from within a container and spray it as a vapor upon the area to be contacted. In these, and other cases, large caps are also necessary to prevent the inadvertent dispensing of the contents during times of non-use, such as when they are packed within a suitcase. As a result of these limitations, travelers are required to carry larger-and-heavier-than-necessary containers to dispense personal hygienic products when they travel.

Similarly, hotels, gyms, and other places in which lavatories are used by individuals for washing or cleaning up frequently place dispensers of hygienic products within the lavatories. Such products, however, are intended for use by “the public” who frequent such washrooms, and there is a possibility that the products may become adulterated, or the dispensing mechanism may come in to physical contact with others, leaving them contaminated or otherwise objectionable for personal use. In the case of underarm deodorant products, it is invariably necessary for commonly-used products to be dispensed as a spray or vapor, so that personal contact between the applicator and a user's skin is avoided. However, many deodorant products are not readily susceptible of vaporization, and the use of gels and semi-solid “sticks” is not possible in single dose applications. What is needed is a singly-packaged, conveniently used dispensing applicator for gels and semi-solid products whose application and use requires direct contact with a user's skin.

It is an object of this invention to provide an application and dispensing apparatus that permits single dosages of gel and semi-solid compositions to be applied directly to a user's skin. It is also an object of this invention to provide a convenient and inexpensive means for packaging of gel and semi-solid compositions for such use. It is a further object of the invention to provide an applicator that contains a sufficient amount of a composition for hygienic use for an intended purpose. It is yet another object of the invention to provide an applicator and packaging that may be thrown away following use. These, and other objects of the invention are more fully described in the following summary of the invention.

### SUMMARY OF THE INVENTION

The apparatus of this invention is formed from two gel-or-semi-solid retaining pads pressed together as a sandwich to contain the gel or semi-solid substance between them, and that, when separated, will each retain a sufficient amount of the substance to provide a single application of the substance to a user's skin. Each pad is comprised of an inner surface that is impermeable to liquid, and that retains the substance upon the surface. In an alternative embodiment, the central portion of the inner pad may be comprised of a porous adsorbent layer having an impermeable layer on the side that is away from the substance being dispensed.

Each pad has an outer surface that is grasped by a user's fingers, and may also have an integrally attached tab for holding between the thumb and fingers. When assembled as a sandwich, the inner surfaces of the two pads retain the substance between them. The pads may be held together simply by the natural adhesion caused by the substance contacting each pad's inner surface. Optionally, a small area around the circumference of the inner surface of each pad may be treated with a mild adhesive to adhere the edges of adjacent pads to one another, forming an enclosed pocket to retain the substance. Conversely, the edges of the inner surfaces of the pads may form an interlocking ridge and/or channel, the purpose of which is to create a barrier against the substance being able to escape from the enclosed pocket until the pads are separated. Other pad retention mechanisms may be used so long as the pads are easily separable and can be inexpensively manufactured.

The substance within the enclosed pocket formed by the pads can be a gel or any other substance that will adhere to the inner surfaces of the pads, yet can be transferred to a user's skin upon coming into contact with the skin. Although the specific viscosity of the substance is variable, it will be understood that substances having viscosities ranging from nearly solid to substantially liquid may be dispensed using the dispensing apparatus of this invention.

The outer surfaces of the pads are intended to be grasped by the thumb and/or fingers. An impermeable inner surface, or an impermeable layer between the inner and outer surface, will prevent the substance from leaking through the pad and coming into contact with the user's thumb and fingers. The outer surface of the pad may be roughened to prevent slippage when the pad is held in the user's hand. Further control over the pad may be achieved by including a tab or other protuberance on the outer surface that may be grasped by the user.

The sandwich formed by the pads can be separated by grasping each pad and pulling the sandwich apart, or through a rotary twisting motion intended to break the seal holding the pads together before separating them. If desired, a small air hole may be included within one pad or each of the pads that, upon being grasped by the user, will permit air to enter the enclosed pocket and permit the separation of the pads with less effort than otherwise would be necessary.

The sandwich can be packaged in a foil or other flexible or semi-rigid container, and each container may be sold as an individual unit or as one of a number of like units being sold in larger quantities. In use, a user will tear the foil packaging to access the sandwich, and will separate the sandwich into two halves, each half retaining approximately one-half of the substance to be applied. Alternative, if a semi-rigid container is used for packaging the sandwich, the container can be opened and the sandwich removed for use. For underarm deodorants, one pad may be used for each underarm area. Following the dispensing of the substance to the skin, the pad and all other packaging may be thrown away.

### BRIEF DESCRIPTION OF THE DRAWINGS

FIG. 1 is a depiction of the dispenser of this invention.

FIG. 2 is an exploded view of the dispenser of this invention.

FIG. 3 is a view of the interior of the two halves of the dispenser of this invention.

FIG. 4 is a view of the two halves of this invention and an interface connecting them.

FIG. 5 is a view of an embodiment of the invention in which each half includes a gripping tab.

### DETAILED DESCRIPTION OF THE PREFERRED EMBODIMENTS

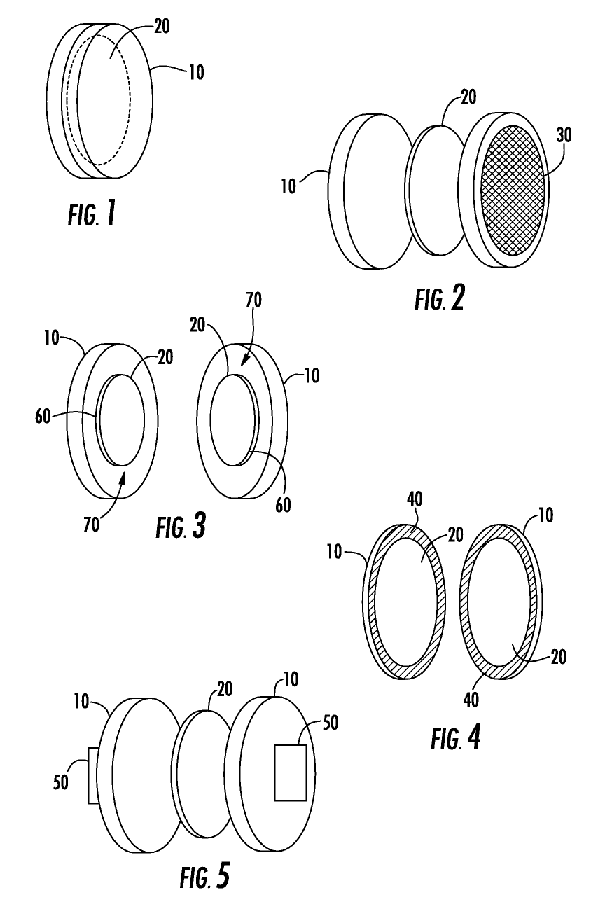

FIG. 1 depicts the dispensing pads 10 of this invention with an embedded gel-pack 20 between them. The gel-pack 20 comprises a medicated or other special purpose substance intended for use through coming into direct contact with the skin.

FIG. 2 shows an exploded view of the dispensing pads 10 of this invention prior to being assembled with a gel-pack between them. To assist a user in gripping the pads 10, an abraised or non-slip area 30 has been affixed to or integrated into the external surface of the pads.

FIG. 3 illustrates the pads 10 of this invention after being separated. A substance intended for direct contact with the skin 20 adheres to the inside of each pad. An impermeable surface 70 is located inside of the pad and insulates the substance from the interior surface of the pad 10. An air passageway 60 is integral to the interior surface of each pad and permits air to be introduced into the central area between the pads when the two halves are being separated.

FIG. 4 shows the interior surfaces of the dispensing pads where circumferential surface areas 40 have treated with an adherent that holds the two pad surfaces together prior to their being separated to expose the substance to be placed into contact with the skin.

FIG. 5 depicts the dispensing pads of this invention 10 having attached tabs 50 to assist a user in separating the pads and holding them during usage.

The substance 20 that is held between the pads can be any medicinal, pharmaceutical, or cosmetic substance, such as moisturizer, deodorant, or the like, that is susceptible of direct application to the skin and that will retain its medicinal or cosmetic properties throughout the manufacture and storage of the dispensing pads.

Persons of ordinary skill in the art will appreciate that the uses for this invention extend beyond the specific embodiments described herein, and are limited only by the claims appended hereto.

I claim:

1. A system for dispensing a substance to be directly applied to the skin comprising:
two dispensing pads joined together prior to use, each said dispensing pad having an inner surface and an outer surface, said inner surfaces forming a cavity prior to being separated and retaining said substance within said cavity, said substance adhering to each of said inner surfaces prior to and during the separation of said dispensing pads and prior to said substance being placed into direct contact with the skin,
said dispensing pads forming a barrier between said substance and a user's fingers to prevent said substance from coming into direct contact with a user's fingers,
said dispensing pads being disposable following the application of said substance to a user's skin.

2. A dispensing system as claimed in claim 1, further comprising a non-slip external surface for said dispensing pads that assists a user to firmly grasp said dispensing pads.

3. A dispensing system as claimed in claim 1, said inner surfaces of said dispensing pads being substantially impermeable to fluids and to said substance whereby said substance does not penetrate through to the external surfaces of said dispensing pads.

4. A dispensing system as claimed in claim 1, said inner surface of each said dispensing pad having a circumferential portion comprising an adhering area whereby said inner surfaces of said dispensing pads adhere to one another when pressed together, said dispensing pads forming an integral unit during packaging and prior to the separation of said dispensing pads.

5. A dispensing system as claimed in claim 1, said external surfaces of said dispensing pads having tabbed appendages for grasping whereby said pads can be separated and used to apply said substance by grasping said tabbed appendages and forcing said pads apart.

6. A dispensing system as claimed in claim 1, said inner surfaces of said dispensing pads forming an air passageway from said external surfaces into said cavity whereby air can be introduced into said cavity during the separation of said dispensing pads.
